(19) United States
(12) Patent Application Publication
(10) Pub. No.: US 2026/0028249 A1
(43) Pub. Date: Jan. 29, 2026

(54) CONTROL METHOD FOR FILTRATION SYSTEM, ELECTRONIC DEVICE, STORAGE MEDIUM, AND FILTRATION SYSTEM

(71) Applicant: Kohler (China) Investment Co., Ltd., Shanghai (CN)

(72) Inventors: Tonggang PAN, Shanghai (CN); Wenjie REN, Shanghai (CN)

(21) Appl. No.: 19/280,067

(22) Filed: Jul. 24, 2025

(30) Foreign Application Priority Data
Jul. 24, 2024 (CN) 202411003721.8

(51) Int. Cl. C02F 1/00

(52) U.S. Cl. CPC C02F 1/003; C02F 1/008; C02F 2201/005; C02F 2201/006; C02F 2209/006; C02F 2209/03; C02F 2209/10; C02F 2209/40; C02F 2209/44; C02F 2303/16

(57) ABSTRACT

A control method for a filtration system, an electronic equipment and a storage medium and a filtration system. The control method includes in response to a user starting a water taking event, opening an inlet valve of the filtration system, in response to a user stopping the water taking event, performing a wastewater rinsing on a filter cartridge of the filtration system, obtaining a water quality of the filtration system, and adjusting the wastewater rinsing process according to the water quality, and closing the inlet valve after completing the wastewater rinsing. The systems and methods allows the adjustment of the wastewater rinsing process according to filtered water quality when users stop taking water. For scenarios with poor water quality, the systems and methods ensure adequate rinsing of the filter cartridge, whereas for better water quality, the systems and methods prevent excessive rinsing of the filter cartridge, which could cause waste of water resources.

### RELATED APPLICATIONS

The present application claims priority to Chinese Patent Application No. 202411003721.8, filed Jul. 24, 2024, which is incorporated by reference herein in its entirety.

### FIELD

The application relates to the technical field of sanitary devices, and more specifically, to a control method for a filtration system, electronic equipment, storage medium, and a filtration system.

### BACKGROUND

In the existing filtration system, the function of zero-aged water is realized by quantitative pure water replacement, and water quality with total dissolved solids (TDS) value of 500 parts per million or ppm is generally used for the simulation test. However, there is a great difference between the actual water quality and the tested water quality, and the filtration system of the prior art basically sets a constant wastewater discharge time to provide a fixed volume of pure water such that the wastewater discharge time is basically the same regardless of the water quality. Therefore, in the filtration system of the prior art, for places where the water quality is very poor, such as when the TDS exceeds 800 ppm, the Reverse Osmosis (RO) filter cartridge cannot be sufficiently rinsed, the water in the pipeline is contaminated, and the function of zero-aged water cannot be realized. For places with better water quality, water resources are wasted due to excessive rinsing of the filter cartridge.

### SUMMARY

Based on this, aiming at the technical problem of the inability to adapt to water quality adjustment due to a fixed wastewater discharge time in the prior art, it is necessary to provide a control method for a filtration system, electronic equipment, a storage medium, and a filtration system.

Examples of the present disclosure of the instant application provides a control method for a filtration system, and may include in response to a user starting a water taking event, opening an inlet valve of the filtration system; in response to the user stopping the water taking event, performing a wastewater rinsing on a filter cartridge of the filtration system, obtaining a water quality of the filtration cartridge, and adjusting the wastewater rinsing process according to the water quality, and closing the inlet valve after completing the wastewater rinsing.

Further, performing the wastewater rinsing on the filter cartridge of the filtration system, obtaining the water quality of the filtration system, and adjusting the wastewater rinsing process according to the water quality in response to the user stopping the water taking event may include obtaining a total dissolved solids of the filtered water of the filtration system, and determining a wastewater rinsing time for a first-stage wastewater rinsing according to the total dissolved solids, opening a wastewater valve of a filter cartridge of the filtration system to perform the first-stage wastewater rinsing within the wastewater rinsing time, closing the wastewater valve, detecting a real-time total dissolved solids of the filtered water in real time, and performing a second-stage wastewater rinsing until the real-time total dissolved solids is less than a drinking water threshold value.

Further, determining the wastewater rinsing time for the first-stage wastewater rinsing according to the total dissolved solids may include, if the total dissolved solids is less than or equal to a sewage minimum threshold value, setting the wastewater rinsing time for the first-stage wastewater rinsing as a second time, if the total dissolved solids is greater than the sewage minimum threshold value and less than or equal to a sewage maximum threshold value, setting the wastewater rinsing time for the first-stage wastewater rinsing as the second time plus an adjustment time, the sewage maximum threshold value is greater than the sewage minimum threshold value, and, if the total dissolved solids is greater than the sewage maximum threshold value, setting the wastewater rinsing time for the first-stage wastewater rinsing as a first time plus the adjustment time, the first time is greater than the second time.

Furthermore, determining the wastewater rinsing time for the first-stage wastewater rinsing according to the total dissolved solids, may also include obtaining a current water pressure, and determining the adjustment time according to the total dissolved solids and the current water pressure, or obtaining a current water flow rate, and determining the adjustment time according to the total dissolved solids and the current water flow rate.

Further, in response to the user starting the water taking event, opening the inlet valve of the filtration system may include in response to the user starting the water taking event, opening the inlet valve of the filtration system and obtaining a current water pressure, and adjusting the rinsing pressure on the filter cartridge of the filtration system according to the current water pressure.

Furthermore, adjusting the rinsing pressure on the filter cartridge of the filtration system according to the current water pressure may include, if the current water pressure is within a preset pressure range, controlling a booster pump located at an inlet end of the filter cartridge in the filtration system to rinse the filter cartridge in the filtration system at a default rotational speed, if the current water pressure is less than a minimum value of the preset pressure range, controlling the booster pump to rinse the filter cartridge in the filtration system at a first gear, a rotational speed of the booster pump at the first gear is greater than the default rotational speed, and if the current water pressure is greater than a maximum value of the preset pressure range, controlling the booster pump to rinse the filter cartridge in the filtration system at a second gear, a rotational speed of the booster pump at the second gear is less than the default rotational speed.

Furthermore, after closing the inlet valve, the method may also include maintaining a pressure relief valve in the filtration system open, and controlling the booster pump in communication with the filter cartridge and a pressure water tank to initial an internal circulation rinsing time, wherein the filter cartridge is sequentially in communication with the pressure relief valve, the pressure water tank and the booster pump to form an internal circulation pipeline in the filtration system, and closing the pressure relief valve and closing the booster pump.

Examples of the disclosure of the instant application provides electronic equipment which may include at least one processor, and a memory communicatively connected to the at least one processor, in which the memory stores instructions executable by the at least one processor, the instructions are executed by the at least one processor to enable the at least one processor to perform the control method for the filtration system as previously described.

Examples of the present application provide a storage medium, the storage medium storing a computer instruction for performing all steps of the control method for the filtration system as previously described when a computer executes the computer instructions.

Examples of the present application provide a computer program product, comprising a computer program/instruction, the computer program/instruction implements the control method for the filtration system as described above when the computer program/instruction is executed by a processor.

Examples of the present application provide a filtration system, comprising a controller and a discharge channel, the discharges channel comprises an inlet valve, a filter cartridge, an outlet valve and a water taking device that are fluidly connected in sequence, wherein the discharge channel is also provided with one or more total dissolved solids probes, wherein the inlet valve, the outlet valve and the total dissolved solids probe are communicatively connected with the controller, and the controller executes the control method for the filtration system as previously described.

Examples of the present application adjusts the wastewater rinsing process according to filtered water quality when users stop taking water. For scenarios with poor water quality, it ensures adequate rinsing of the filter cartridge, whereas for better water quality, it prevents excessive rinsing of the filter cartridge, which could cause waste of water resources.

### DESCRIPTION OF THE DRAWINGS

The disclosure may be more completely understood in consideration of the following detailed description of examples of the disclosure in connection with the accompanying drawing, in which:

FIG. 1 is a workflow diagram of a control method for a filtration system of an example of the disclosure;

FIG. 2 is a workflow diagram of a control method for a filtration system of another example of the disclosure;

FIG. 3 is a schematic diagram of the filtration system of an example of the disclosure;

FIG. 4 is a schematic diagram of a water taking process of an example of the disclosure;

FIG. 5 is a schematic diagram of a first-stage wastewater rinsing process of an example of the disclosure;

FIG. 6 is a schematic diagram of a second-stage wastewater rinsing process of an example of the disclosure;

FIG. 7 is a schematic diagram of an internal circulation rinsing process of an example of the disclosure;

FIG. 8 is a schematic diagram of a pressure tank rinsing process of an example of the disclosure;

FIG. 9 is a workflow diagram of a control method for a filtration system in best example of the disclosure;

FIG. 10 is a logical schematic diagram for automatically adjusting the rinsing pressure of a booster pump according to the water pressure in the best example of the disclosure;

FIG. 11 is a logical schematic diagram for automatically adjusting the rinsing time according to different water qualities in the best example of the disclosure; and

FIG. 12 is a schematic diagram of the hardware structure of an electronic equipment of the disclosure.

While various examples are amenable to various modifications and alternative forms, specifics thereof have been shown by way of example in the drawings and will be described in detail. It should be understood, however, that the intention is not to limit the claimed inventions to the particular examples described. On the contrary, the intention is to cover all modifications, equivalents, and alternatives falling within the spirit and scope of the subject matter as defined by the claims.

### LIST OF REFERENCE NUMBERS

1. inlet valve; 2. filter cartridge; 3. outlet valve; 4. water taking device; 5. total dissolved solids probe; 6. booster pump; 7. pressure sensor; 8. wastewater valve; 9. pressure water tank; 10. pressure relief valve; 11. Pre-filter cartridge.

### DETAILED DESCRIPTION

The following detailed description should be read with reference to the figures in which similar or identical elements in different figures are numbered the same. The figures, which are not necessarily to scale, depict illustrative examples and are not intended to limit the scope of the disclosure. It should also be understood that the terminology used herein is for the purpose of description only and should not be regarded as limiting. Common definitions are generally intended for the terminology used herein unless a specific definition is provided. In the case of a term having a common definition and a specific definition provided herein, the term should be construed according to its specific definition.

The specific examples of the disclosure will be further described with reference to the drawings hereinafter. Same parts are denoted by the same reference numerals. It should be noted that the terms “front”, “rear”, “left”, “right”, “up” and “down” used in the following description refer to the directions in the drawings, and the terms “inner” and “outer” refer to the directions towards or away from geometric centers of specific parts, respectively.

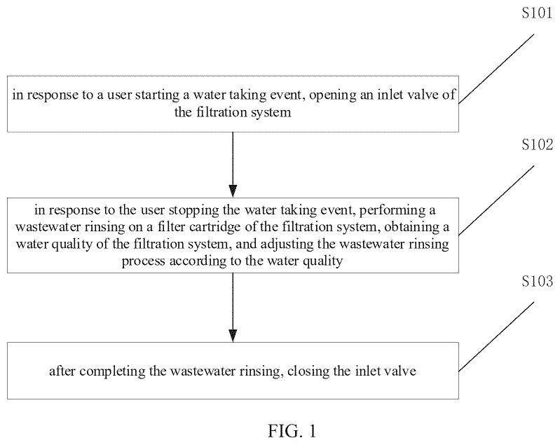

As shown in FIG. 1, a workflow diagram of a control method for a filtration system of an example of the present application is depicted. In step S101, in response to a user starting a water taking event, an inlet valve of the filtration system may be opened. In step S102, in response to the user stopping the water taking event, a wastewater rinsing on a filter cartridge of the filtration system may be performed, a water quality of the filtration system may be obtained, and the wastewater rinsing process according to the water quality may be adjusted. In step S103, after completing the wastewater rinsing, the inlet valve may be closed. Specifically, the application may be applied to electronic equipment, for example, a controller. with processing capability.

When the user starts to take water, step S101 is triggered to open the inlet valve of the filtration system. Then, when the user stops taking water, step S102 is triggered to perform the wastewater rinsing on the filter cartridge of the filtration system. In some examples, the method also may comprise judging the starting of the water taking event and the stopping of the water taking event according to the pressure in the pipe.

Specifically, the outlet valve is controlled by a user to open and close. The pressure in the pipe can be monitored by setting a pressure switch/high pressure switch at an outlet position, and the pressure switch can be integrated into the outlet valve. When the outlet valve is opened, the pressure in the pipeline decreases, the pressure switch/high pressure switch is closed, and it is determined that the user starts to take water, and step S101 is performed to open the inlet valve. When the user controls the outlet valve to close it, the pressure in the pipe increases, the pressure switch/high pressure switch is opened, and it is determined that the user stops taking water, and step S102 performs the wastewater rinsing. The wastewater rinsing is to rinse the filter cartridge. Therefore, during the wastewater rinsing, only the outlet valve is closed, but the inlet valve is left open to rinse the filter cartridge. Meanwhile, the water quality of the filtration system is obtained, and the wastewater rinsing process is adjusted based on the water quality. The quality of filtered water may be expressed by total dissolved solids (TDS).

Finally, step S103 is performed, and after the wastewater rinsing has been performed, the inlet valve is closed.

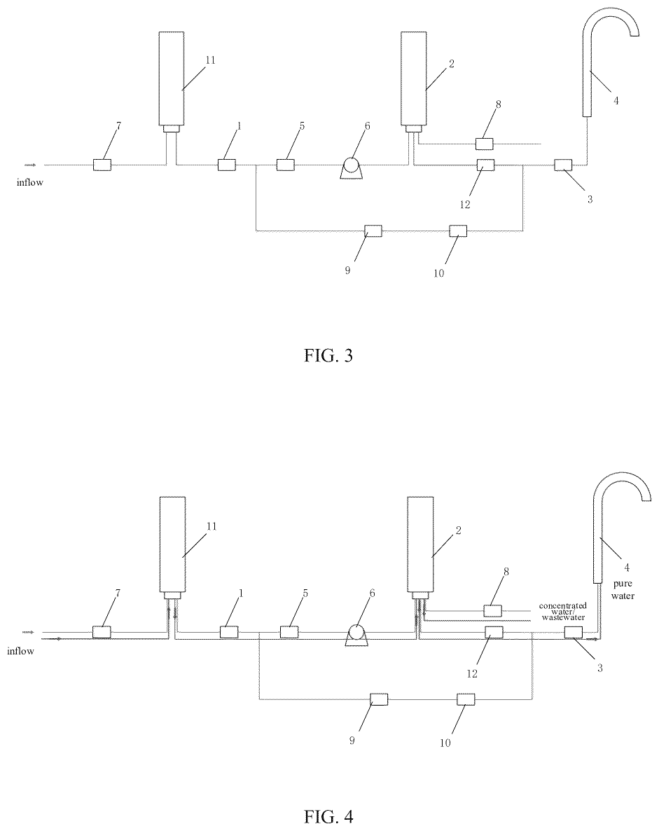

The control method of the present application is used for controlling a filtration system with zero-aged water, such as the filtration system shown in FIG. 3. As shown in FIG. 3, a filtration system according to an example of the present disclosure, may comprise a controller and a discharge channel, wherein the discharge channel comprises an inlet valve 1, a filter cartridge 2, an outlet valve 3, and a water taking device 4 that are fluidly connected in sequence, wherein the discharge channel may also be provided with one or more total dissolved solids probes, wherein the inlet valve 1, the outlet valve 3, and the total dissolved solids probe are communicatively connected with the controller, and the controller executes the control method for the filtration system as previously described.

In some examples, the total dissolved solids probe may comprise an inflow total dissolved solids probe 5 located at the inlet end of the filter cartridge 2 and an outflow total dissolved solids probe 12 located at the outlet end of the filter cartridge 2.

When the user opens the outlet valve 3, step S101 is triggered to open the inlet valve 1, and the user takes water from the water taking device 4. When the user closes the outlet valve 3, step S102 is triggered to determine the water quality of the filtered water according to the TDS value output by the total dissolved solids probe 5. Finally, after performing step S103, the inlet valve 1 is closed.

The filter cartridge 2 may be a reverse osmosis filter cartridge and/or a nanofiltration filter cartridge. The inlet valve 1 and outlet valve 3 may be solenoid valves, which are controlled to open or close by a controller. The inflow total dissolved solids probe 5 and the outflow total dissolved solids probe 12 output the detected TDS values to the controller, and the controller determines the time of wastewater rinsing. The TDS value detected by the inflow total dissolved solids probe 5 is the inflow TDS value, and the TDS value detected by the outflow total dissolved solids probe 12 is the outflow TDS value.

Examples according to the present disclosure include the ability to adjust the wastewater rinsing process according to filtered water quality when users stop taking water. For scenarios with poor water quality, it ensures adequate rinsing of the filter cartridge, whereas for better water quality, it prevents excessive rinsing of the filter cartridge, which could cause waste of water resources.

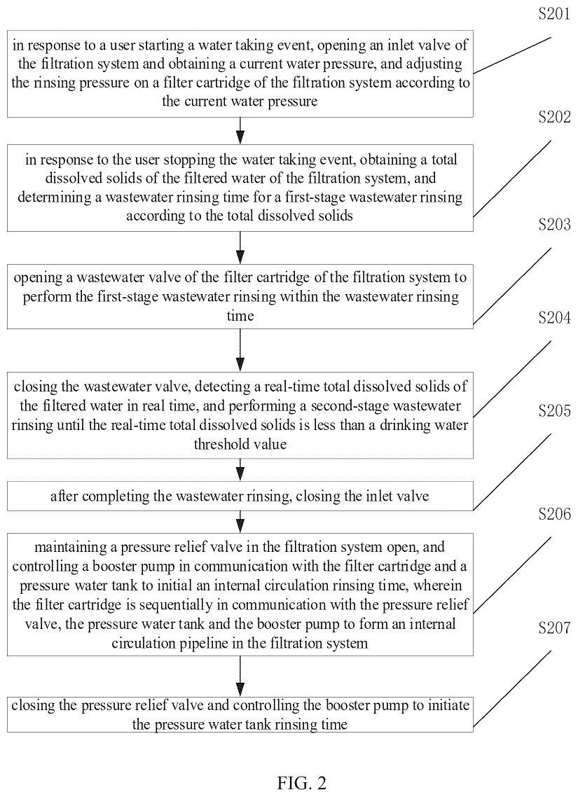

As shown in FIG. 2, a workflow diagram of a control method for a filtration system of another example of the present disclosure is depicted. In step S201, in response to a user starting a water taking event, an inlet valve of the filtration system may be opened, and a current water pressure is obtained. The rinsing pressure on a filter cartridge of the filtration system according to the current water pressure may be adjusted.

In one of the examples, if the current water pressure is within a preset pressure range, a booster pump located at an inlet end of the filter cartridge in the filtration system may be controlled to rinse the filter cartridge in the filtration system at a default rotational speed. If the current water pressure is less than a minimum value of the preset pressure range, the booster pump may be controlled to rinse the filter cartridge in the filtration system at a first gear, a rotational speed of the booster pump at the first gear is greater than the default rotational speed. If the current water pressure is greater than a maximum value of the preset pressure range, the booster pump is controlled to rinse the filter cartridge in the filtration system at a second gear, a rotational speed of the booster pump at the second gear is less than the default rotational speed.

In step S202, in response to the user stopping the water taking event, a total dissolved solids of the filtered water of the filtration system is obtained, and a wastewater rinsing time for a first-stage wastewater rinsing according to the total dissolved solids is determined.

In one of the examples, if the total dissolved solids is less than or equal to a sewage minimum threshold value, the wastewater rinsing time for the first-stage wastewater rinsing is set as a second time. If the total dissolved solids is greater than the sewage minimum threshold value and less than or equal to a sewage maximum threshold value, the wastewater rinsing time for the first-stage wastewater rinsing is set as a second time plus an adjustment time, the sewage maximum threshold value is greater than the sewage minimum threshold value. If the total dissolved solids is greater than the sewage maximum threshold value, the wastewater rinsing time for the first-stage wastewater rinsing is set as a first time plus the adjustment time, the first time is greater than the second time.

In one of the examples, a current water pressure is obtained, and the adjustment time is determined according to the total dissolved solids and the current water pressure, or a current water flow rate is obtained, and the adjustment time according to the total dissolved solids and the current water flow rate is determined.

In step S203, a wastewater valve of a filter cartridge of the filtration system may be opened to perform the first-stage wastewater rinsing within the wastewater rinsing time.

In step S204, the wastewater valve may be closed, a real-time total dissolved solids of the filtered water may be detected in real time, and a second-stage wastewater rinsing may be performed until the real-time total dissolved solids is less than a drinking water threshold value.

In step S205, after completing the wastewater rinsing, the inlet valve may be closed.

In step S206, a pressure relief valve in the filtration system is maintained open, and the booster pump is controlled in communication with the filter cartridge and a pressure water tank to initiate an internal circulation rinsing time. The filter cartridge is sequentially in communication with the pressure relief valve, and the pressure water tank and the booster pump to form an internal circulation pipeline in the filtration system.

In step S207, the pressure relief valve is closed and the booster pump is controlled to initiate the pressure water tank rinsing time.

Specifically, when the user starts to take water, step S201 is performed to open the inlet valve and the outlet valve of the filtration system and obtain a current water pressure and adjust the rinsing pressure on the filter cartridge of the filtration system according to the current water pressure.

As shown in FIG. 4, a water taking process is depicted according to an example of the present disclosure. The water flows along the blue line in the figure, enters from the inlet valve 1, and the booster pump 6 provides rinsing pressure to the filter cartridge 2. The pure water obtained after filtered by the filter cartridge 2 finally flows out from the water taking device 4 through the outlet valve 3.

The filter system in some previous systems employs a booster pump to rinse the filter cartridge that have a constant rotational speed. When the water pressure is too low, the water pressure after passing through the booster pump may effectively rinse the filter cartridge. However, at the same rotational speed, when the water pressure is too high, the water pressure passing through the booster pump becomes very high, which puts great pressure on the filter cartridge, increases the pressure at the front end of the filter membrane, increases the risk of membrane damage, greatly shortens the service life of the filter cartridge, and causes fluctuations and instability of the filtration system and water quality. It will also cause waste of water resources at the same time.

Therefore, in the present examples of the disclosure, the rinsing pressure on the filter cartridge is adjusted according to the current water pressure. Specifically, the rinsing pressure on the filter cartridge is adjusted by adjusting the rotational speed of the booster pump.

In one of the examples, if the current water pressure is within a preset pressure range, a booster pump located at an inlet end of the filter cartridge in the filtration system is controlled to rinse the filter cartridge in the filtration system at a default rotational speed. If the current water pressure is less than a minimum value of the preset pressure range, the booster pump is controlled to rinse the filter cartridge in the filtration system at a first gear, a rotational speed of the booster pump at the first gear is greater than the default rotational speed. If the current water pressure is greater than a maximum value of the preset pressure range, the booster pump is controlled to rinse the filter cartridge in the filtration system at a second gear, a rotational speed of the booster pump at the second gear is less than the default rotational speed.

The filtration system shown in FIG. 3 further may comprise a booster pump 6 located at the inlet end of the filter cartridge 2 and a pressure sensor 7 located at the front end of the inlet valve 1, the current water pressure is detected by the pressure sensor, and the rinsing pressure on the filter cartridge 2 is changed by adjusting the rotational speed of the booster pump 6 according to the current water pressure.

Specifically, if the current water pressure is within the preset pressure range, the booster pump employs the default rotational speed. If the current water pressure is less than the minimum value of the preset pressure range, the rinsing pressure is too small, and the booster pump is controlled to operate at the rotational speed of the first gear, and the rinsing pressure is increased by increasing the rotational speed. If the current water pressure is greater than the maximum value of the preset pressure range, the rinsing pressure is excessive, and the booster pump is controlled to operate at the rotational speed of the second gear, and the rinsing pressure is reduced by reducing the rotational speed. Wherein, the first gear is a high-speed gear and the second gear is a low-speed gear.

In this example, the rinsing pressure on the filter cartridge of the filtration system is adjusted according to the current water pressure, and on the one hand, the water pressure is avoided from being too high, thereby extending the service life of the filter cartridge and avoiding waste of water resources. At the same time, it also avoids too low water pressure, which could result in unclean filter element rinsing.

When the user stops taking water, step S202 is performed to obtain a total dissolved solids of the filtered water of the filtration system and determine a wastewater rinsing time for a first-stage wastewater rinsing according to the total dissolved solids.

Specifically, the wastewater rinsing comprises two stages, in the first stage, the outlet valve is closed, the inlet valve is kept open, meanwhile the wastewater valve of the filter cartridge is opened, and the water is drained through the wastewater valve. In the second stage, the outlet valve is kept closed, the inlet valve is kept open, meanwhile the wastewater valve of the filter cartridge is closed.

In examples, the wastewater valve is a normally open valve. The flow rate of the wastewater valve when it is opened is greater than when it is closed. For example, when it is closed, the flow rate is 500 ml/min; when it is opened, the flow rate is 2000 ml/min.

In the first stage, the wastewater valve is opened. The flow rate of the wastewater valve is very high, which may quickly empty the high-concentration wastewater generated during the previous water production and quickly improve the water quality in the waterway. In the second stage, the wastewater valve is closed, and pure water is prepared after opening the water flow to rinse the filter cartridge, further improving the water quality in the waterway.

In some examples, during the first-stage wastewater rinsing process and the second-stage wastewater rinsing process, the booster pump located at the inlet end of the filter cartridge is kept open to rinse the filter cartridge.

The wastewater rinsing time for the first-stage wastewater rinsing is determined according to the water quality of the filtered water. Specifically, it is determined based on the TDS of the filtered water. In one of the examples, if the total dissolved solids is less than or equal to a sewage minimum threshold value, the wastewater rinsing time is set for the first-stage wastewater rinsing as a second time. If the total dissolved solids is greater than the sewage minimum threshold value and less than or equal to a sewage maximum threshold value, the wastewater rinsing time is set for the first-stage wastewater rinsing as a second time plus an adjustment time, the sewage maximum threshold value is greater than the sewage minimum threshold value. If the total dissolved solids is greater than the sewage maximum threshold value, the wastewater rinsing time is set for the first-stage wastewater rinsing as a first time plus the adjustment time, the first time is greater than the second time.

In the present example, when the TDS value of the filtered water is less than or equal to the sewage minimum threshold value, the wastewater rinsing time for the first-stage wastewater rinsing is the second time T2. When the TDS value of filtered water is greater than the sewage minimum threshold value and less than or equal to the sewage maximum threshold value, the wastewater rinsing time for the first-stage wastewater rinsing is T2+ΔT, and ΔT is the adjustment time. If the TDS value of filtered water is greater than the sewage maximum threshold value, the wastewater rinsing time for the first-stage wastewater rinsing is T1+ΔT, T1 is the first time, and T1>T2.

In some examples, the total dissolved solids is the inflow total dissolved solids. The wastewater rinsing time for the first-stage wastewater rinsing is determined according to the total dissolved solids. If the inflow total dissolved solids is less than or equal to a sewage minimum threshold value, the wastewater rinsing time for the first-stage wastewater rinsing is set as a second time. If the inflow total dissolved solids is greater than the sewage minimum threshold value and less than or equal to a sewage maximum threshold value, the wastewater rinsing time is set for the first-stage wastewater rinsing as a second time plus an adjustment time, the sewage maximum threshold value is greater than the sewage minimum threshold value. If the inflow total dissolved solids is greater than the sewage maximum threshold value, the wastewater rinsing time is set for the first-stage wastewater rinsing as a first time plus the adjustment time, the first time is greater than the second time.

Since the pure water at the position of the inflow total dissolved solids probe 5 does not participate in the rinsing process, the TDS data detected by the inflow total dissolved solids probe 5 is more accurate, and thus, the time of wastewater rinsing is determined according to the TDS value detected by the inflow total dissolved solids probe 5.

In this example, the corresponding first-stage wastewater rinsing time is respectively set according to the TDS value of the filtered water, so as to adapt to different water quality conditions, and avoid excessive cleaning while keeping a clean rinsing.

In one of the examples, the wastewater rinsing time for the first-stage wastewater rinsing is determined based on the total dissolved solids, may also be as follows. A current water pressure is obtained, and the adjustment time according to the total dissolved solids and the current water pressure is determined, or a current water flow rate is obtained, and the adjustment time is determined according to the total dissolved solids and the current water flow rate.

Specifically, the adjustment time ΔT is a time value calculated by a software algorithm according to parameters such as a TDS value, water pressure, and water flow rate. Firstly, the rinsing time corresponding to the TDS value under the standard water pressure or standard water flow rate is determined as ΔT. The rinsing time is then adjusted according to the current water pressure or current water flow rate. Specifically, when the current water pressure is lower than the standard water pressure, or when the current flow rate is lower than the standard flow rate, the rinsing time is extended, and when the current water pressure is higher than the standard water pressure, or when the current water flow rate is higher than the standard flow rate, the rinsing time is reduced. The specific extension time or reduction time may be determined through calibration.

In some examples, the total dissolved solids is the inflow total dissolved solids, and the wastewater rinsing time for the first-stage wastewater rinsing is determined based on the total dissolved solids, as follows. A current water pressure is obtained, and the adjustment time is determined according to the inflow total dissolved solids and the current water pressure, or a current water flow rate is obtained, and the adjustment time is determined according to the inflow total dissolved solids and the current water flow rate. This example dynamically determines the adjustment time according to the TDS value, water pressure and water flow rate to adapt to different water flow conditions.

After determining the wastewater rinsing time, step S203 is performed to open a wastewater valve of a filter cartridge of the filtration system and perform the first-stage wastewater rinsing within the wastewater rinsing time.

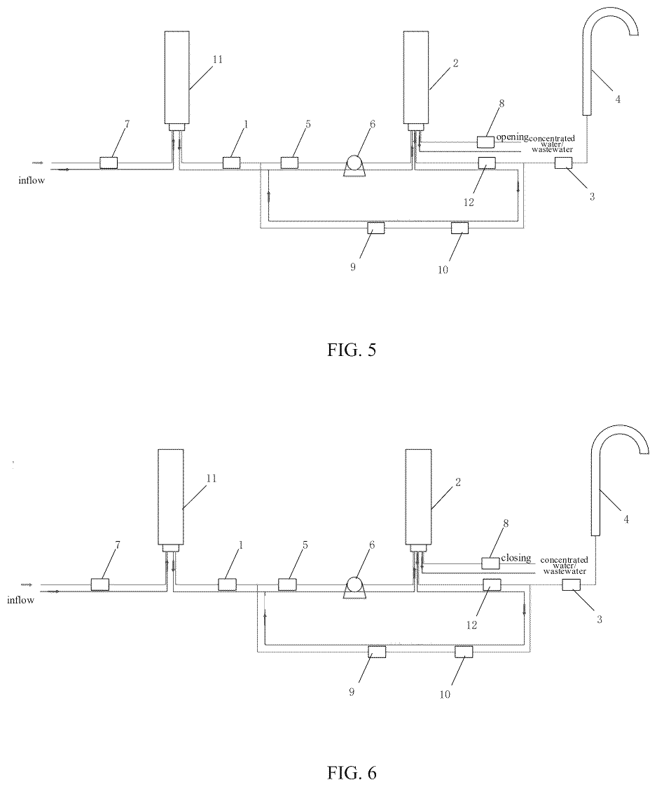

As shown in FIG. 5, it is a first-stage wastewater rinsing process. In the first-stage wastewater rinsing process, the wastewater valve 8 of the filter cartridge 2 is opened, and the water flow flows in the direction of the arrow in the figure to drain wastewater/concentrated water. The wastewater valve 8 may also be called the concentrated water valve.

In some examples, the filtration system also comprises an internal circulation pipeline formed by a filter cartridge 2, a pressure relief valve 10 and a pressure water tank 9 that are fluidly connected. The pressure water tank 9 may also be fluidly connected with the filter cartridge 2 through the booster bump 6.

During the first-stage wastewater rinsing process, the pressure relief valve 10 is kept open, meanwhile the filtered water flows in the internal circulation pipeline in the direction of the arrow in the figure.

After the first-stage wastewater rinsing is completed, step S204 is preformed to close the wastewater valve, a real-time total TDS value of the filtered water in real time is detected, and a second-stage wastewater rinsing is performed until the real-time total dissolved solids is less than a drinking water threshold value. Specifically, after closing the wastewater valve, a second stage wastewater rinsing is performed.

As shown in FIG. 6, it is a second-stage wastewater rinsing process. In the second-stage wastewater rinsing process, the wastewater valve 8 is closed, and the water flow flows in the direction of the arrow in the figure.

During the second-stage wastewater rinsing, the TDS value of the filtered water is detected in real time, and when the real-time TDS value is less than the drinking water threshold value, the second-stage wastewater rinsing is stopped. Step S205 is performed to close the inlet valve.

In some examples, stopping the second-stage wastewater rinsing may comprise closing the inlet valve and keeping the booster pump operating.

In some examples, the total dissolved solids is the outflow total dissolved solids. The wastewater valve is closed, a real-time total dissolved solids of the filtered water us detected in real time, and a second-stage wastewater rinsing is performed until the real-time total dissolved solids is less than a drinking water threshold.

In some examples, the filtration system also comprises an internal circulation pipeline formed by a filter cartridge 2, a pressure relief valve 10 and a pressure water tank 9 that are fluidly connected. The pressure water tank 9 may be also fluidly connected with the filter cartridge 2 through the booster bump 6.

During the second-stage wastewater rinsing process, the pressure relief valve 10 is kept open, meanwhile the filtered water flows in the internal circulation pipeline in the direction of the arrow in the figure. Then step S206 is performed to maintain a pressure relief valve in the filtration system open, and to control the booster pump in communication with the filter cartridge and a pressure water tank to initiate an internal circulation rinsing time, and perform internal circulation rinsing.

As shown in FIG. 3, the filtration system also may comprise an internal circulation pipeline formed by a filter cartridge 2, a pressure relief valve 10, and a pressure water tank 9 that are fluidly connected. The pressure water tank 9 may be also fluidly connected with the filter cartridge 2 through the booster bump 6.

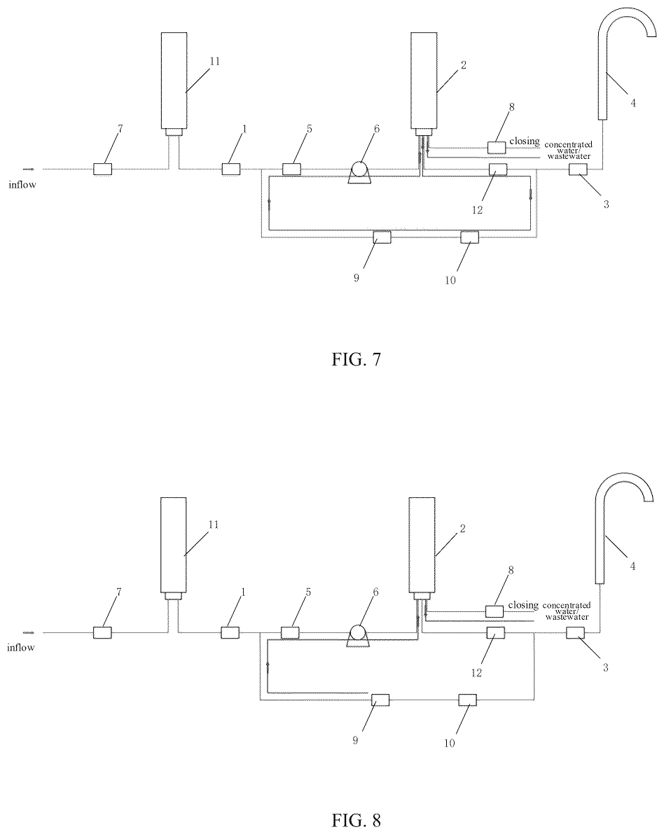

As shown in FIG. 7, it is an internal circulation rinsing process. The pressure water tank 9 is driven by a spring or an air bag, etc. When the inlet valve 1 is closed, the filtered water circulates in the internal circulation pipeline formed by the filter cartridge 2, the pressure relief valve 10 and the pressure water tank 9 as shown by the arrow in the figure to complete the internal circulation rinsing.

Finally, after keeping the pressure relief valve open and initiating internal circulation rinsing time, step S207 is performed to close the pressure relief valve and control the booster pump to initiate the pressure tank rinsing time, and to conduct pressure tank rinsing.

As shown in FIG. 8, a pressure tank rinsing process is depicted. When the pressure relief valve 10 is closed, the pressure water tank 9 is driven by a spring or an air bag, and the filtered water enters the filter cartridge 2 from the pressure water tank 9 as shown by the arrow in the figure.

Examples of the present disclosure adjusts the wastewater rinsing time according to filtered water quality when users stop taking water. For scenarios with poor water quality, it ensures adequate rinsing of the filter cartridge, whereas for better water quality, it prevents excessive rinsing of the filter cartridge, which may cause waste of water resources. This example automatically adjusts the rinsing pressure of the booster pump according to the water pressure, so that the life of the filter cartridge may be prolonged under different water pressures. The present example has a drainage amount of wastewater that may be self-adapting and adjusting, and during the filtration process, the drainage amount of wastewater may be dynamically adjusted according to the inflow TDS value. According to the logic of phased automatic adjustment of the rinsing time in this example, the rinsing time is adjusted according to different water quality, which not only allows users to drink clean water, but also achieves the purpose of saving water and energy. Meanwhile, this example may automatically adjust the operation mode of the booster pump according to the water pressure of the unused incoming water and may effectively save energy while increasing the service life of the filter cartridge. In addition, due to different inlet water quality, the TDS at the wastewater end of the osmotic membrane will also be different, and the time and amount of water required for rinsing will be different. According to the control method of the present example, the water quality range to which the function of zero-aged water may be adapted is wider, and the realization of the function, water saving, and the reduction of membrane usage are taken into account. It provides stable drinking water quality, saves water resources, and prolongs the cycle and time of filter cartridge replacement. Finally, the present example employs an internal circulation rinsing and pressure tank rinsing. During internal circulation and pressure tank rinsing, only pure water participates in the rinsing process, and no inlet water (tap water) flows in, so that the waterway rinsing is more thorough and a better cleaning effect is achieved.

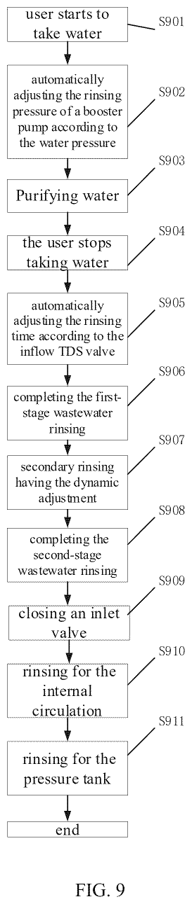

As shown in FIG. 9, a workflow diagram of a control method for a filtration system of an example of the present disclosure is depicted. In this Figure, in step S901, the user starts to take water. In step S902, the rinsing pressure of a booster pump is adjusted according to the water pressure. In step S903, water is purified. In step S904, the user stops taking water. In step S905, the rinsing time is automatically adjusted according to the inflow TDS valve. In step S906, the first-stage wastewater rinsing is completed. In step S907, a secondary rinsing having the dynamic adjustment is initiated. In step S908, the second-stage wastewater rinsing is completed. In step S909, the inlet valve is closed. In step S910, rinsing for the internal circulation is initiated. In step S911, rinsing for the pressure tank is initiated.

In this example, on the basis of the filtration system, the functions of dynamically adjusting the wastewater draining time and the operation mode of the booster pump according to different water quality and water pressure of the inlet water are added. Specifically, this example controls the filtration system shown in FIG. 3.

As shown in FIG. 4, the user starts to take water and steps S901 to S903 are performed. Then, when the user stops taking water, step S904 is triggered.

The rinsing process is divided into three (3) stages, and with a fourth stage being optional, as shown in FIG. 4.

Rinsing stage 1 includes draining the high-concentration wastewater in the system. Specifically, as shown in FIG. 5, steps S905-S906 are performed to conduct the first-stage wastewater rinsing.

Rinsing stage 2 includes preparing pure water to improve the water quality in the system, and to make the water in the system meet the drinking requirements. Specifically, as shown in FIG. 6, steps S907-S909 are performed to conduct the second-stage wastewater rinsing.

Rinsing stage 3 includes further circulating the water in the system to make the water quality distribution in the system more evenly. Specifically, as shown in FIG. 7, steps S910 is performed to conduct the internal circulation rinsing.

Optional rinsing stage 4 includes further draining the concentrated water at the wastewater end of the filter cartridge, which may further reduce the TDS value of the first cup of water and extend the rinsing interval (extend the standby time). Specifically, as shown in FIG. 8, step S911 is performed to conduct the pressure tank rinsing.

It will be noted from FIG. 9 that in the entire process of the RO machine:
1) The logic of automatically adjusting the rinsing pressure of the booster pump according to the water pressure enables the filter cartridge to have an extended service life under different water pressures.
2) The logic of automatically adjusting the rinsing time in stages, which adjusting the rinsing time according to different water qualities, not only allows users to drink clean water, but also achieves the purpose of saving water and energy.

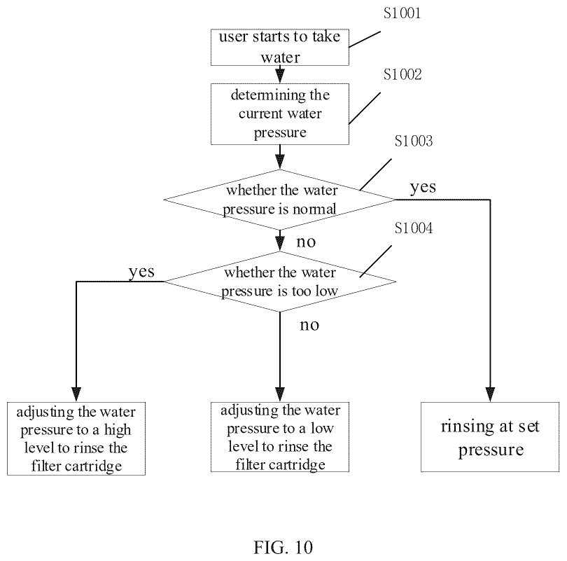

As shown in FIG. 10, the logic of automatically adjusting the rinsing pressure of the booster pump according to the water pressure in steps S901 to S902 is depicted. In step S1001, the user starts to take water. In step S1002, the current water pressure is determined. In step S1003, it is determined whether the water pressure is normal. If it is normal, rinsing is performed at the set pressure (i.e. the booster pump is turned on and operates at the default speed), otherwise, step S1004 is performed. In step S1004, whether the water pressure is too low is determined. If yes, the water pressure is adjusted to a high level to rinse the filter cartridge, otherwise the water pressure is adjusted to a low level to rinse the filter cartridge.

In addition, a pressure sensor may be added after the booster pump, which may adjust multiple gears according to the outlet pressure of the booster pump.

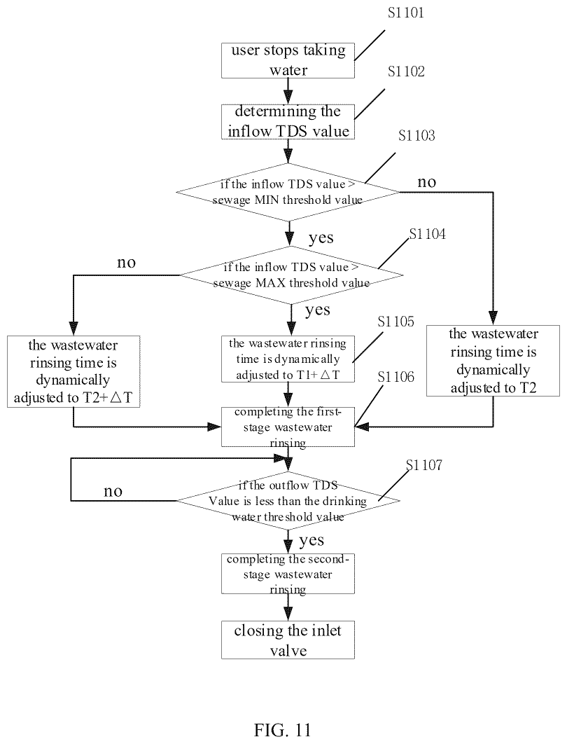

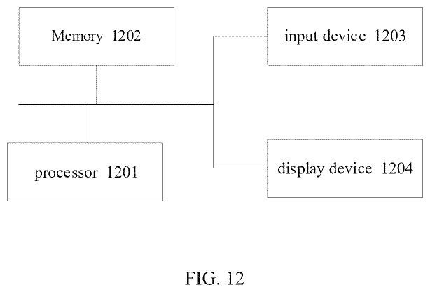

As shown in FIG. 11, the logic of automatically adjusting the rinsing time according to the different water qualities for steps S904 to S909 is depicted. In step S1101, the user stops taking water. In step S1102, the inflow TDS value is determined, in which the inflow TDS value may be the TDS value detected by the inflow total dissolved solids probe 5. In step S1103, if the inflow TDS value is greater than the sewage minimum (MIN) threshold value, step S1104 is performed, otherwise the wastewater rinsing time is dynamically adjusted to T2. Step S1104, if the inflow TDS value is greater than sewage maximum (MAX) threshold value, step S1105 is performed, otherwise the wastewater rinsing time is dynamically adjusted to T2+ΔT. In step S1105, the wastewater rinsing time is dynamically adjusted to T1+ΔT; In step S1106, the first-stage wastewater rinsing is completed. In step S1107, if the outflow TDS value is less than the drinking water threshold value, the second-stage wastewater rinsing is completed, and the inlet valve is closed. Otherwise, step S1107 is continued, in which the outflow TDS value may be the TDS value detected by the outflow total dissolved solids probe 12.

The example is applied to the product of the filter with RO reverse osmosis cartridge filter or the filter with ultra-nano filter cartridge, and has a drainage amount of wastewater that may be self-adapting and adjusting, and during the filtration process, the drainage amount of wastewater may be dynamically adjusted according to the inflow TDS value, meanwhile, the operation mode of the booster pump may be automatically adjusted according to the water pressure of unused incoming water, so as to increase the service life of the filter cartridge and effectively save energy.

As shown in FIG. 12, a schematic diagram of the hardware structure of an electronic equipment of the application may comprise at least one processor 1201, and a memory 1202 communicatively connected to the at least one processor 1201. The memory 1202 may store instructions executable by the at least one processor. The instructions are executed by the at least one processor to enable the at least one processor to perform the control method of the filtration system as previously described. An example of one processor 1201 is shown in FIG. 12.

The electronic equipment may also comprise an input device 1203 and a display device 1204. The processor 1201, the memory 1202, the input device 1203, and the display device 1204 may be connected via a bus or other means, and the connection via a bus is shown as an example.

The memory 1202, as a non-volatile computer readable storage medium, may be used to store non-volatile software programs, non-volatile computer executable programs, and modules, such as the program instructions/modules corresponding to the control method of the filtration system in this application example, for example, the method flow shown in FIG. 1 and FIG. 2. The processor 1201 executes various functional applications and data processing by running the non-volatile software programs, instructions, and modules stored in the memory 1202, i.e., realizing the control method of the filtration system in the above example.

The memory 1202 may comprise a stored program area and a stored data area, in which the stored program area may store the operating system, at least one the application program required by function, and the stored data area may store data created according to the use of the control method of the filtration system, etc. In addition, the memory 1202 may comprise high-speed random access memory, and may also comprise non-volatile memory, such as at least one disk memory device, flash memory device, or other non-volatile solid state memory device. In some examples, memory 1202 may optionally comprise memory that is remotely located relative to processor 1201, and these remote memories may be connected via a network to a device that performs a control method of the filtration system. Examples of the networks may comprise, but are not limited to, the Internet, corporate intranets, local area networks, mobile communication networks, and its combinations thereof.

The input device 1203 may receive input user clicks and generate a signal input related to user settings as well as function control of the control method of the filtration system. Display device 1204 may comprise a display equipment such as a display screen.

The one or more modules are stored in the memory 1202, and when run by the one or more processors 1201, execute the control method of the filtration system of any of the method examples described above.

The present application adjusts the wastewater rinsing process according to filtered water quality when users stop taking water. For scenarios with poor water quality, it ensures adequate rinsing of the filter cartridge, whereas for better water quality, it prevents excessive rinsing of the filter cartridge, which could cause waste of water resources.

One example of the present disclosure provides a storage medium, the storage medium storing computer instructions for performing all steps of the control method for the filtration system as previously described when a computer executes the computer instructions.

In the context of the present disclosure, a storage medium may be a tangible medium that may contain or store a program for use by or in conjunction with an instruction execution system, device, or equipment. The storage medium may be a machine-readable signal medium or a machine-readable storage medium. Optionally, the storage medium may be a non-transitory computer-readable storage medium, for example, a non-transitory computer-readable storage medium may be a ROM, a random access memory (RAM), a compact Disc ROM (CD-ROM), a magnetic tape, a floppy disk, and an optical data storage device, etc.

One example of the present disclosure provides a computer program product which may include a computer program/instruction that implements the control method of the filtration system as described above when the computer program/instruction is executed by a processor.

As shown in FIG. 3, a filtration system in an example of the present disclosure is depicted and may comprise a controller (not shown) and a discharge or outlet channel. The outlet channel may comprise an inlet valve 1, a filter cartridge 2, an outlet valve 3 and a water taking device 4 that are fluidly connected in sequence. The discharge channel may also be provided with one or more total dissolved solids probes. The inlet valve 1, the outlet valve 3, and the total dissolved solids probe are communicatively connected with the controller, and the controller executes the control method for the filtration system as previously described. The inlet valve 1, the outlet valve 3, the total dissolved solids probe and the controller employ the existing communication method and are connected through wired or wireless communication.

In some examples, the total dissolved solids probe may comprise an inflow total dissolved solids probe 5 located at the inlet end of the filter cartridge 2 and an outflow total dissolved solids probe 12 located at the outlet end of the filter cartridge 2.

In some examples, the filtration system may further comprise a booster pump 6 located at the inlet end of the filter cartridge 2, and a pressure sensor 7 located at the front end of the inlet valve 1, the current water pressure is detected by the pressure sensor, and the rinsing pressure on the filter cartridge 2 is changed by adjusting the rotational speed of the booster pump 6 according to the current water pressure.

In some examples, the filtration system may also comprise a pre-filter cartridge provided between the pressure sensor 7 and the inlet valve 1.

In some examples, filter cartridge 2 may also be provided with a wastewater valve 8 to drain wastewater/concentrated water.

In some examples, the filtration system also comprises an internal circulation pipeline formed by a filter cartridge 2, a pressure relief valve 10, and a pressure water tank 9 that are fluidly connected. The pressure water tank 9 may also be fluidly connected with the filter cartridge 2 through the booster bump 6.

In some examples, the inlet valve 1 and outlet valve 3 are solenoid valves. The outlet valve 3 may be a solenoid valve with an integrated pressure switch/high pressure switch.

In example, the functions of each component are as follows:

The inlet valve 1 is used to control an opening/closing of the incoming water.

The filter cartridge 2 may comprise a nanofiltration and/or reverse osmosis filter cartridge for removing impurities in water.

The outlet valve 3 is used to control the opening/closing of filtered drinking water.

The water taking device 4 is used by the user to obtain drinking water, and the water taking device 4 may be a faucet.

The inflow total dissolved solids probe 5 and the outflow total dissolved solids probe 12 are used to monitor the water quality conditions.

The booster pump 6 is used to increase the water pressure in a pipeline.

The pressure sensor 7 is used to monitor the inlet water pressure.

The wastewater valve 8 is a normally open valve. The flow rate of the wastewater valve when it is open is greater than when it is closed. In a non-limiting example, when it is closed, the flow rate is 500 ml/min; when it is opened, the flow rate is 2000 ml/min. The wastewater valve 8 is used to control the rinsing of wastewater.

The pressure water tank 9 is used to store clean water for further rinsing the filter cartridge. The pressure relief valve 10 is used to control the opening/closing of the internal circulation pipeline formed by the filter cartridge 2, the pressure relief valve 10, and the pressure water tank 9 that are fluidly connected.

The pre-filter cartridge 11 is used for primary filtration to remove residual chlorine and large particles.

The filtration system of the present application detects the water quality of the filtered water by adding the total dissolved solids probes, so that it adjusts the wastewater rinsing time according to filtered water quality when users stop taking water. For scenarios with poor water quality, it ensures adequate rinsing of the filter cartridge, whereas for better water quality, it prevents excessive rinsing of the filter cartridge, which could cause waste of water resources.

The above-described examples only express several examples of the application, and their descriptions are more specific and detailed, but they are not to be understood as a limitation of the patent scope of the application. It should be pointed out that, for those of ordinary skills in the art, several other modifications and improvements may be made on the basis of the principle of the application, which should also be regarded as falling in the protection scope of the application. Therefore, the scope of protection of the patent of the present application shall be subject to the appended claims.

Various examples of systems, devices, and methods have been described herein. These examples are given only by way of example and are not intended to limit the scope of the claimed disclosures. It should be appreciated, moreover, that the various features of the examples that have been described may be combined in various ways to produce numerous additional examples. Moreover, while various material, dimensions, shapes, configurations, locations, etc. have been described for use with disclosed examples, others besides those disclosed may be utilized without exceeding the scope of the claimed disclosures.

Persons of ordinary skill in the relevant arts will recognize that the subject matter hereof may comprise fewer features than illustrated in any individual example described above.

The examples described herein are not meant to be an exhaustive presentation of the ways in which the various features of the subject matter hereof may be combined. Accordingly, the examples are not mutually exclusive combinations of features; rather, the various examples may comprise a combination of different individual features selected from different individual examples, as understood by persons of ordinary skill in the art. Moreover, elements described with respect to one example may be implemented in other examples even when not described in such examples unless otherwise noted.

Any incorporation of reference of documents above is further limited such that no claims included in the documents are incorporated by reference herein. Any incorporation by reference of documents above is yet further limited such that any definitions provided in the documents are not incorporated by reference herein unless expressly included herein. For purposes of interpreting the claims, it is expressly intended that the provisions of 35 U.S.C. § 112 (f) are not to be invoked unless the specific terms “means for” or “step for” are recited in a claim.

What is claimed is:

1. A control method for a filtration system, comprising:
opening an inlet valve of the filtration system in response to a user starting a water taking event;
in response to the user stopping the water taking event, performing a wastewater rinsing process on a filter cartridge of the filtration system by obtaining a water quality of the filtration system and adjusting the wastewater rinsing process according to the water quality; and
closing the inlet valve after completing the wastewater rinsing process.

2. The control method for the filtration system according to claim 1, wherein performing the wastewater rinsing process on the filter cartridge of the filtration system comprises:
obtaining a total dissolved solids of the filtered water of the filtration system, and determining a wastewater rinsing time for a first-stage wastewater rinsing according to the total dissolved solids;
opening a wastewater valve of the filter cartridge of the filtration system to perform the first-stage wastewater rinsing within the wastewater rinsing time;
closing the wastewater valve, detecting a real-time total dissolved solids of the filtered water in real time, and performing a second-stage wastewater rinsing until the real-time total dissolved solids is less than a drinking water threshold value.

3. The control method for the filtration system according to claim 2, wherein determining the wastewater rinsing time for the first-stage wastewater rinsing according to the total dissolved solids comprises:
if the total dissolved solids is less than or equal to a sewage minimum threshold value, setting the wastewater rinsing time for the first-stage wastewater rinsing as a second time;
if the total dissolved solids is greater than the sewage minimum threshold value and less than or equal to a sewage maximum threshold value, setting the wastewater rinsing time for the first-stage wastewater rinsing as a second time plus an adjustment time, the sewage maximum threshold value is greater than the sewage minimum threshold value; and
if the total dissolved solids is greater than the sewage maximum threshold value, setting the wastewater rinsing time for the first-stage wastewater rinsing as a first time plus the adjustment time, the first time is greater than the second time.

4. The control method for the filtration system according to claim 3, wherein determining the wastewater rinsing time for the first-stage wastewater rinsing according to the total dissolved solids, also comprises:
obtaining a current water pressure and determining the adjustment time according to the total dissolved solids and the current water pressure; or
obtaining a current water flow rate and determining the adjustment time according to the total dissolved solids and the current water flow rate.

5. The control method for the filtration system according to claim 1, wherein opening an inlet valve of the filtration system in response to the user starting the water taking event comprises:
in response to the user starting the water taking event, opening the inlet valve of the filtration system and obtaining a current water pressure; and
adjusting the rinsing pressure on the filter cartridge of the filtration system according to the current water pressure.

6. The control method for the filtration system according to claim 5, wherein adjusting the rinsing pressure on the filter cartridge of the filtration system according to the current water pressure, comprises:
if the current water pressure is within a preset pressure range, controlling a booster pump located at an inlet end of the filter cartridge in the filtration system to rinse the filter cartridge in the filtration system at a default rotational speed;
if the current water pressure is less than a minimum value of the preset pressure range, controlling the booster pump to rinse the filter cartridge in the filtration system at a first gear, wherein a rotational speed of the booster pump at the first gear is greater than the default rotational speed; and
if the current water pressure is greater than a maximum value of the preset pressure range, controlling the booster pump to rinse the filter cartridge in the filtration system at a second gear, wherein a rotational speed of the booster pump at the second gear is less than the default rotational speed.

7. The control method for the filtration system according to claim 1, wherein after closing the inlet valve, the method further comprises:
maintaining a pressure relief valve in the filtration system open, and controlling the booster pump in communication with the filter cartridge and a pressure water tank to initiate an internal circulation rinsing time, wherein the filter cartridge is sequentially in communication with the pressure relief valve, the pressure water tank, and the booster pump to form an internal circulation pipeline in the filtration system; and
closing the pressure relief valve and closing the booster pump.

8. Electronic equipment for performing the control method for the filtration system of claim 1, comprising:
at least one processor; and
a memory communicatively connected to the at least one processor,
wherein the memory stores instructions executable by the at least one processor, and the instructions are executed by the at least one processor to enable the at least one processor to perform the control method for the filtration system.

9. A storage medium configured to store computer instructions for performing the control method for the filtration system according to claim 1 when a computer executes the computer instructions.

10. A filtration system comprising a controller and a discharge channel, wherein the discharge channel comprises:
an inlet valve;
a filter cartridge;
an outlet valve; and
a water taking device; wherein the inlet valve, filter cartridge, outlet valve and water taking device are fluidly coupled in sequence, and
wherein the discharge channel includes one or more total dissolved solids probes, wherein the inlet valve, the outlet valve and the total dissolved solids probe are communicatively connected with the controller, and wherein the controller executes a control method for the filtration system according to claim 1.
